(19) United States
(12) Patent Application Publication
(10) Pub. No.: US 2014/0122532 A1
(43) Pub. Date: May 1, 2014

(54) IMAGE COMPARISON PROCESS

(71) Applicant: Google Inc., Mountain View, CA (US)

(72) Inventors: Tomasz Charytoniuk, San Francisco, CA (US); Doug Sherrets, New York, NY (US)

(73) Assignee: Google Inc., Mountain View, CA (US)

(21) Appl. No.: 14/068,970

(22) Filed: Oct. 31, 2013

Related U.S. Application Data
(60) Provisional application No. 61/720,483, filed on Oct. 31, 2012.

(51) Int. Cl. G06F 17/30

(52) U.S. Cl. CPC G06F 17/30256
USPC 707/780

(57) ABSTRACT

A computer-implemented method and computing system for receiving, on a computing device, a tag associated with a first user concerning a first image within a social network. The method may be further configured to scan the first image to identify whether a human face is present in the first image. If the human face is identified, the method may be configured to compare the human face to that of the first user. If the human face is determined to be that of the first user, the method may be configured to allow the first image to be displayed in a social networking application associated with a second user, wherein the first user and second user are connected within the social network.

### CROSS-REFERENCE TO RELATED APPLICATIONS

This application claims the benefit of U.S. Provisional Application having Ser. No. 61/720,483, filed Oct. 31, 2012, of which the entire contents are incorporated herein by reference.

### TECHNICAL FIELD

This disclosure relates to comparing images and, more particularly, to comparing tagged images with one or more users associated with a social network.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public website in which they may post entries that are published for multiple people to read. Examples of such websites may include but are not limited to product/service review sites, social networks, and topical blogs. Through the use of such social networks, users may exchange content such as photographs. Further, users may discuss and provide commentary on such photographs.

Many social websites allow the users to tag other people in photos. For example, someone might tag a friend and so that photo might appear in their stream and on the profile of the person they know. However, sometimes these photos don't actually include the person, but they still are included in the stream, and they are less interesting to the user because they aren't actually the user's friend.

### SUMMARY OF DISCLOSURE

In a first implementation, a computer-implemented method includes receiving, on a computing device, a tag associated with a first user concerning a first image within a social media stream of a social network. The method may further include scanning the first image to identify whether a human face is present in the first image. If the human face is identified, the method may also include comparing the human face to that of the first user, wherein data relating to features of the first user are stored in a database. If the human face is determined to be associated with that of the first user, the method may include allowing the first image to be displayed in a social networking application associated with a second user, wherein the first user and second user are connected within the social network. If the human face is not determined to be that of the first user, the method may also include preventing the display of the first image on the social media stream of the social network.

In another implementation, a computer-implemented method includes receiving, on a computing device, a tag associated with a first user concerning a first image within a social network. The method may include scanning the first image to identify whether a human face is present in the first image. If the human face is identified, the method may further include comparing the human face to that of the first user. If the human face is determined to be that of the first user, the method may also include allowing the first image to be displayed in a social networking application associated with a second user, wherein the first user and second user are connected within the social network.

One or more of the following features may be included. If the human face is not that of the first user, the method may include preventing the display of the first image on the social network. If the human face is not that of the first user, the method may include de-emphasizing the display of the first image on the social network. In some embodiments, de-emphasizing may include reducing the size of the first image. In some embodiments, de-emphasizing may include adjusting a display position of the first image on the social network. In some embodiments, comparing may include comparing the human face to a database of contacts associated with the social network. In some embodiments, the method may include providing one or more of the first user and the second user with a notice indicating an incorrect tag is associated with the first image. In some embodiments, the method may include providing one or more of the first user and the second user with an option to remove the incorrect tag from the first image. In some embodiments, the method may include requesting permission from one or more of the first user and the second user prior to allowing the first image to be displayed.

In another implementation, a computing system includes a processor and memory configured to perform operations including receiving, on a computing device, a tag associated with a first user concerning a first image within a social network. Operations may include scanning the first image to identify whether a human face is present in the first image. If the human face is identified, operations may further include comparing the human face to that of the first user. If the human face is determined to be that of the first user, operations may also include allowing the first image to be displayed in a social networking application associated with a second user, wherein the first user and second user are connected within the social network.

One or more of the following features may be included. If the human face is not that of the first user, operations may include preventing the display of the first image on the social network. If the human face is not that of the first user, operations may include de-emphasizing the display of the first image on the social network. In some embodiments, de-emphasizing may include reducing the size of the first image. In some embodiments, de-emphasizing may include adjusting a display position of the first image on the social network. In some embodiments, comparing may include comparing the human face to a database of contacts associated with the social network. In some embodiments, operations may include providing one or more of the first user and the second user with a notice indicating an incorrect tag is associated with the first image. In some embodiments, operations may include providing one or more of the first user and the second user with an option to remove the incorrect tag from the first image. In some embodiments, operations may include requesting permission from one or more of the first user and the second user prior to allowing the first image to be displayed. In some embodiments, adjusting a display position may include adjusting a position of the first image in a social networking stream.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an image comparison process according to an embodiment of the present disclosure;

FIG. 2 is a flowchart of the image comparison process of FIG. 1 according to an embodiment of the present disclosure;

FIG. 3 is a diagrammatic view of a social network user interface according to an embodiment of the present disclosure;

FIG. 4 is a diagrammatic view of a social network user interface according to an embodiment of the present disclosure;

FIG. 5 is a diagrammatic view of a social network user interface according to an embodiment of the present disclosure;

FIG. 6 is a diagrammatic view of a social network user interface according to an embodiment of the present disclosure;

FIG. 7 is a diagrammatic view of a social network user interface according to an embodiment of the present disclosure; and

FIG. 8 is a diagrammatic view of the computing device of FIG. 1 according to an embodiment of the present disclosure.

Like reference symbols in the various drawings indicate like elements.

### DETAILED DESCRIPTION OF THE EMBODIMENTS

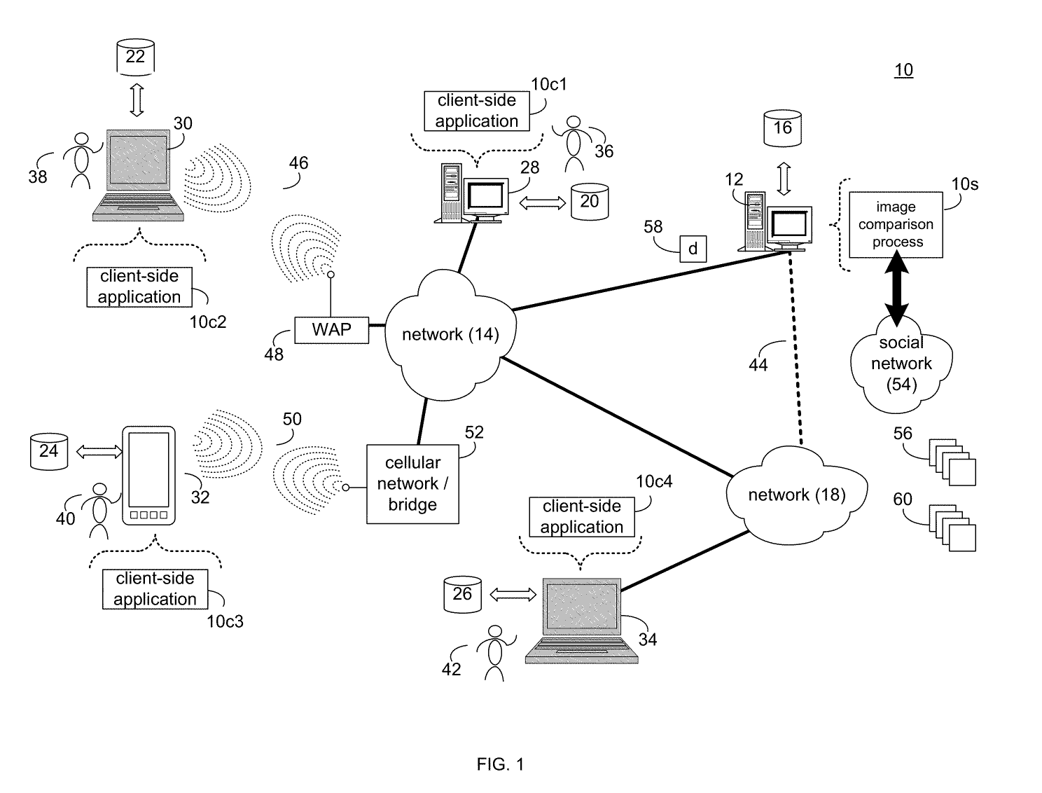

Referring to FIG. 1, there is shown image comparison process 10. For the following discussion, it is intended to be understood that image comparison process 10 may be implemented in a variety of ways. For example, image comparison process 10 may be implemented as a server-side process, a client-side process, or a server-side/client-side process. Any user, if they so choose, may elect to disable any or all of the features associated with image comparison process 10.

For example, image comparison process 10 may be implemented as a purely server-side process via image comparison process 10s. Alternatively, image comparison process 10 may be implemented as a purely client-side process via one or more of client-side application 10c1, client-side application 10c2, client-side application 10c3, and client-side application 10c4. Alternatively still, image comparison process 10 may be implemented as a server-side/client-side process via image comparison process 10s in combination with one or more of client-side application 10c1, client-side application 10c2, client-side application 10c3, and client-side application 10c4.

Accordingly, image comparison process 10 as used in this disclosure may include any combination of image comparison process 10s, client-side application 10c1, client-side application 10c2, client-side application 10c3, and client-side application 10c4.

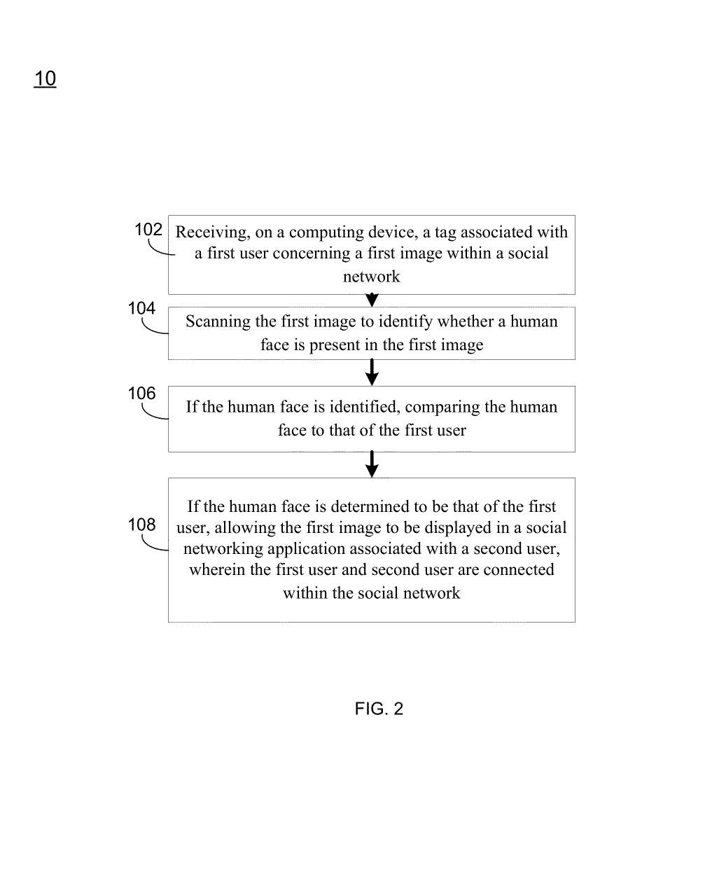

Referring also to FIG. 2 and as will be discussed below in greater detail, image comparison process 10 may receive 102 a tag associated with a first user concerning a first image within a social network. The method may be further configured to scan 104 the first image to identify whether a human face is present in the first image. If the human face is identified, the method may be configured to compare 106 the human face to that of the first user. If the human face is determined to be that of the first user, the method may be configured to allow 108 the first image to be displayed in a social networking application associated with a second user, wherein the first user and second user are connected within the social network.

Image comparison process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of image comparison process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, a television user interface, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, desktop computer 28, laptop computer 30, data-enabled, cellular telephone 32, notebook computer 34, a server computer (not shown), a personal gaming device (not shown), a data-enabled television console (not shown), a personal music player (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access image comparison process 10 directly through network 14 or through secondary network 18. Further, image comparison process 10 may be accessed through secondary network 18 via link line 44.

The various client electronic devices (e.g., client electronic devices 28, 30, 32, 34) may be directly or indirectly coupled to network 14 (or network 18). For example, desktop computer 28 is shown directly coupled to network 14 via a hardwired network connection. Laptop computer 30 is shown wirelessly coupled to network 14 via wireless communication channel 46 established between laptop computer 30 (respectively) and wireless access point (i.e., WAP) 48, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Further, data-enabled, cellular telephone 32 is shown wirelessly coupled to network 14 via wireless communication channel 50 established between data-enabled, cellular telephone 32 and cellular network/bridge 52, which is shown directly coupled to network 14. Additionally, notebook computer 34 is shown directly coupled to network 18 via a hardwired network connection.

Image comparison process 10 may be configured to interact with social network 54. An example of social network 54 may include but is not limited to Google+™. Accordingly, image comparison process 10 may be configured to be a portion of/included within social network 54. Alternatively, image comparison process 10 may be configured to be a stand-alone process that interacts with (via e.g., an API) social network 54. Social network 54 may be configured to allow users (e.g., users 36, 38, 40, 42) to post various images (e.g., plurality of images 56) within social network 54 for commentary by other users.

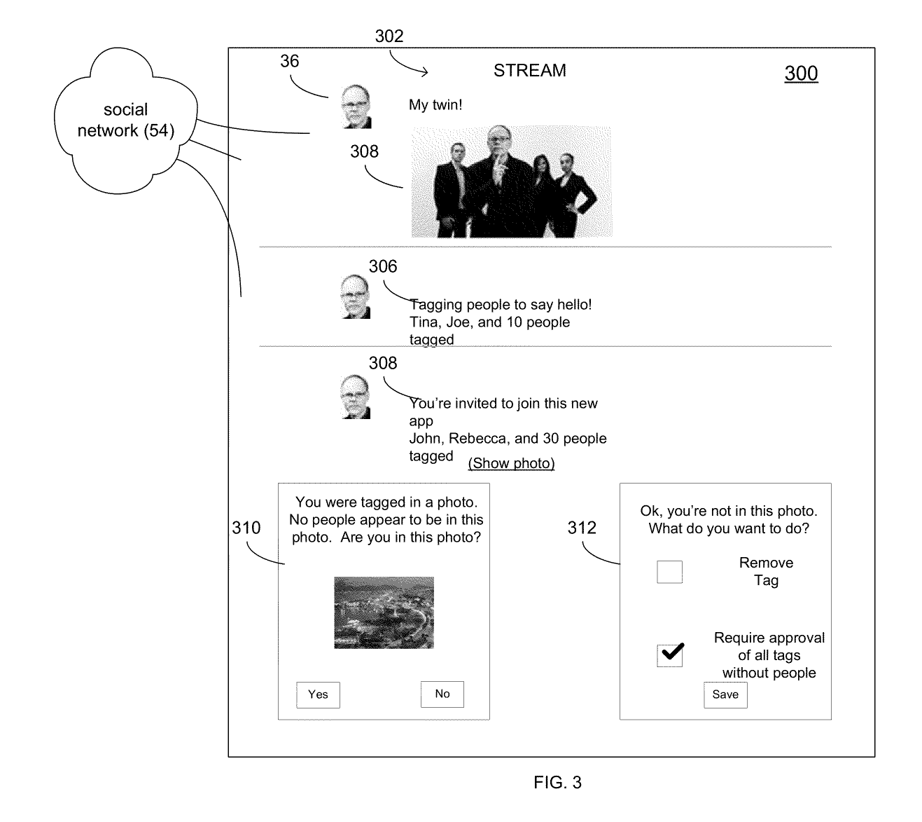

Referring also to FIG. 3, assume for illustrative purposes that social network 54 is configured to render user interface 300 for use by users 36, 38, 40, 42 (who may all be members of social network 54). User interface 300 may be configured to include a social networking stream 302 as is shown, which may be associated with a particular user of the social network.

In some embodiments, image comparison process 10 may be configured to receive 102 (e.g. at server computing device 12) a tag associated with a first user concerning a first image within a social network. In the example shown in FIG. 3, first user 36 may tag 306 an image such as image 308 shown in social networking stream 302. Accordingly, image comparison process 10 may be configured to scan 104 the first image to identify whether a human face is present in the first image. The scanning may occur using any suitable device. For example, in some embodiments, the scanning may occur at server computing device 12, which may be associated with one or more storage devices 16. Storage device 16 may include a database of contacts associated with social network 54 and may also include facial features corresponding to some or all of the social networking contacts. In this way, server computing device may also include facial recognition capabilities as is discussed in further detail below.

In some embodiments, and assuming a human face has been identified in image 308 by image comparison process 10, image comparison process 10 may also be configured to compare 106 the human face shown in image 308 with that of first user 36. The comparison may be optional, for example, if the user has opted to prevent the comparison from occurring. If the human face is determined to be that of first user 36, image comparison process 10 may allow first image 308 to be displayed in a social networking application associated with a second user (e.g. second user 38). As discussed above, the first user and the second user may be members of the social network.

In some embodiments, the user may be provided with an option to manually approve the tag, or to always approve the tag. The approved tag may associate the data of the image with that of the first user. The data may surface in the stream of people who are connected to the first user, on the user's profile, or in other places within the product.

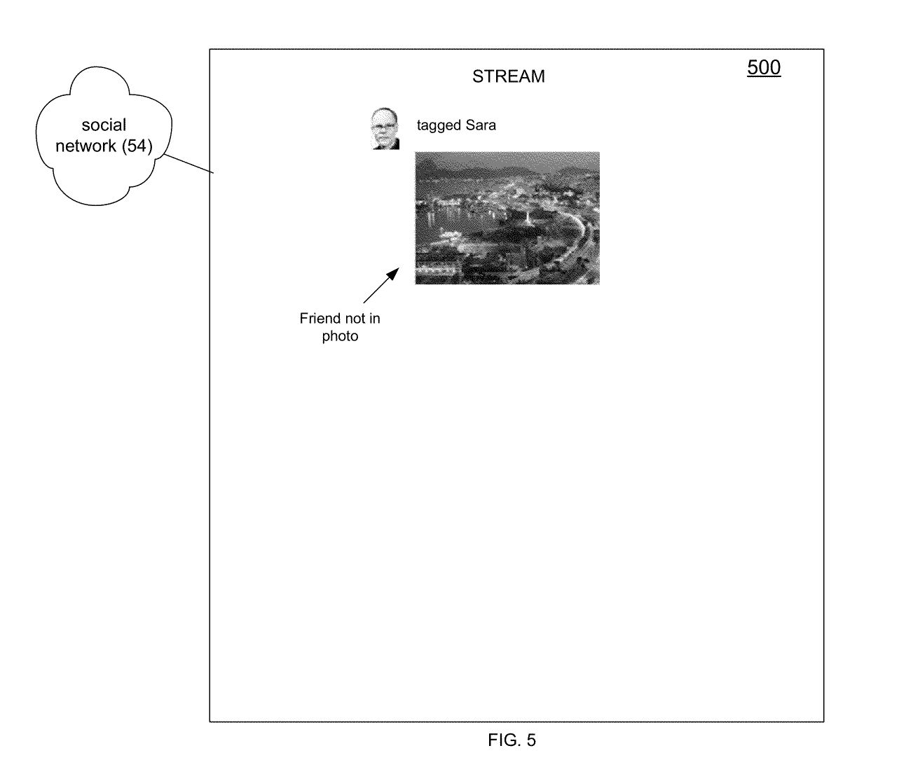

In some embodiments, and referring now to FIG. 5, if the human face is not that of the first user, image comparison process 10 may prevent the display of the first image on the social network. Additionally and/or alternatively, if the human face is not that of the first user, image comparison process 10 may de-emphasize the display of the first image on the social network. Accordingly, de-emphasizing may include, but is not limited to, reducing the size of the first image, adjusting a display position of the first image on the social network or numerous other techniques.

In some embodiments, image comparison process 10 may prevent the display of the image using any suitable approach. For example, the user may be prompted to allow and/or prevent the photo from being connected to their account, or the user may have a predefined setting where they chose to always approve or prevent tags which don't actually contain their face. If the tag is prevented, the image may not be shown on the tagged user's profile. It also may not surface in the stream of people who are connected to that user within the social network. In some cases, the tag may possibly be entirely hidden to all viewers of the photo except for the photo owner who made the inaccurate tag.

Additionally and/or alternatively, image comparison process 10 may be configured to provide one or more of the first user and the second user with a notice indicating an incorrect tag is associated with the first image. For example, image comparison process 10 may generate notice 310. In some embodiments, image comparison process 10 may provide one or more of the first user and the second user with an option to remove the incorrect tag from the first image as is shown in menu 312.

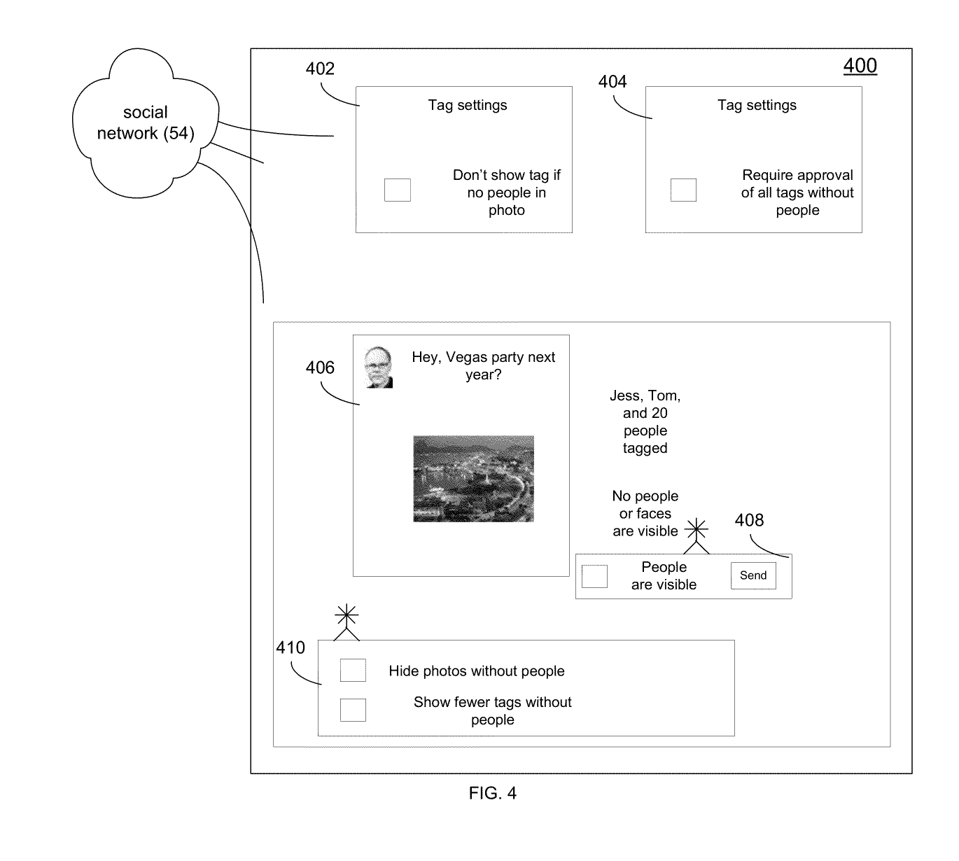

Referring now to FIG. 4, an embodiment of an interface 400 generated by image comparison process 10 is provided. Interface 400 may be configured to request permission from one or more of the first user and the second user prior to allowing the first image to be displayed. Accordingly, image comparison process 10 may generate tag settings menus 402 and 404, which may allow a user to prevent the display of an image if it is determined that there are no people in the image or photograph. In some embodiments, some or all of the features generated may be alone or together (e.g. settings menus 402 and 404 may be generated separately from content displayed on the page, etc.). Further, image comparison process 10 may be configured to allow a user to review all tagged images that do not include any people prior to displaying.

In some embodiments, image comparison process 10 may be configured to allow an image or photograph to be tagged with a contact of a user of a social network. The photograph may be scanned to identify whether a human face appears and/or whether a human face appears in the area that is tagged. The faces identified may be compared with the face of the friend in the photos the friend is tagged in to identify similarities. Accordingly, image comparison process 10 may utilize facial recognition capabilities or any suitable technology for matching faces. In some embodiments, faces that match may be allowed to appear in the stream and the profile. Additionally and/or alternatively, faces that don't match may be prevented from appearing and/or reduced in rank so that they are less likely to appear in the stream. The user may either see the tagged photo or not depending on what was ranked.

In some embodiments, image comparison process 10 may be configured to show a full photo based on an any occurrence of user feedback of comments/shares/etc. Additionally and/or alternatively, image comparison process 10 may collapse or reduce the size of an image or photo in case of bad feedback.

In some embodiments, image comparison process 10 may be configured to use facial recognition to tend to surface photos of people who appear to be friends with a user when posted by people the user is connected to. A higher preference may be given to photos that are uploaded by the friend that the photo appears to include their face in the photo. In some embodiments, image comparison process 10 may be configured to give higher confidence to people that the person who appears to be in the photo when that person has a high social affinity with the person who appears to be in the photo.

In some embodiments, image comparison process 10 may be configured to identify spam or abuse. Accordingly, image comparison process 10 may be configured to hide photos from users and applications found to abuse tags. A link may be provided, which when clicked may result in expansion of the photo.

In some embodiments, users may not want tags showing when they're not in the photo. Accordingly, image comparison process 10 may be configured to notify the first time it looks like a user isn't in a photo and offer to remove the tag and require approvals in the future for photos that appear to not have people in them. Additionally and/or alternatively, image comparison process 10 may, by default, require approval for tags in photos where there don't appear to be people and/or when a person such as a friend tagged clicks to say that no person is in the photo. Whether a person is determined to be in photo could be based on some confidence level.

In some embodiments, image comparison process 10 may be configured to provide users with control of tagged photos not showing any people. Accordingly, image comparison process 10 may be configured to provide a setting on the stream about showing or not showing photos in the stream that appear to not have people in the photos. Image comparison process 10 may be configured to allow users to select that people are identified in the photo.

In some embodiments, a photo may be tagged with a user's friend. The photo may be scanned to identify whether a human face appears. The photo may then be scanned to identify whether a human face appears in the area that is tagged. The faces identified may be compared with the face of the user's friend in the photos that the friend is tagged in to identify similarities. Technology for matching faces may be used. In some embodiments, as an initial operation, the people shown may be asked for permission to do this. The faces that don't match are caused to not appear, reduced in rank so that they are less likely to appear in the stream, reduced in image size, and/or photo is hidden unless the user clicks to open. Image comparison process 10 may provide the user with a settings features that may allow the user to determine what they want to appear in the stream. For example, a user might have selected to show fewer or no photos where there appear to not be people in the photos. The settings feature may also allow the user to determine what they want to appear if they are tagged. Image comparison process 10 may be configured to determine the settings of users about what they want to confirm tags and may check for users who are tagged for the first time. Image comparison process 10 may send a notification to users who a user doesn't believe to be tagged in a photo and/or if a user doesn't think any people are tagged in the photo. Image comparison process 10 may be configured to send a notification to users who are tagged for the first time asking if they are in the photo. In some embodiments, a user receiving a notification may be prompted to confirm if they are in the photo and/or if any person is the in the photo, then if not, the person may be asked if they want to remove/hide the tag(s) and/or require approval of tags in the future if a photo they're tagged in doesn't appear to show a person. The setting to require approval in the future if a photo you're tagged in doesn't appear to show a person could alternatively be set by default, checked by default, or require a selection. A user may either see the tagged photo or not depending on what was ranked. In some embodiments, a user may select a setting to decide whether to show tags of photos of themselves in the stream.

In some embodiments, image comparison process 10 may display images based upon, at least in part, a confidence level associated with a person or image. For example, the confidence level of tagged person may be higher if a contact's photo is uploaded by the contact. Additionally and/or alternatively, a confidence level of a tagged person may be higher if a photo is uploaded by someone with a high social affinity with the user, the person who uploaded the photo, etc.

Image comparison process 10 may provide the user with control over tagged photos. This control may include, but is not limited to, user control of tagged photos that appear to not have people, user control to not see photos in stream that do not have people, user control to see fewer/more photos in stream that do not have people, user control to require review of photos of them when tagged to decide whether to hide/remove tag before the tagged photo appears in the stream of their friends, user control to determine the confidence level of whether or not a person is determined to appear in the photo or not, user control to report a photo as not having people.

In some embodiments, image comparison process 10 may stream and profile display or not display based on face comparisons. Smaller photos may be generated if it is determined that no people are present. Image comparison process 10 may be configured to size photos based on the person viewing the stream and past interactions with content from that person as well as any tagged photos not showing people. In some embodiments, image comparison process 10 may be configured to provide a link to show the photo and/or may not show the photo in the stream or profile at all.

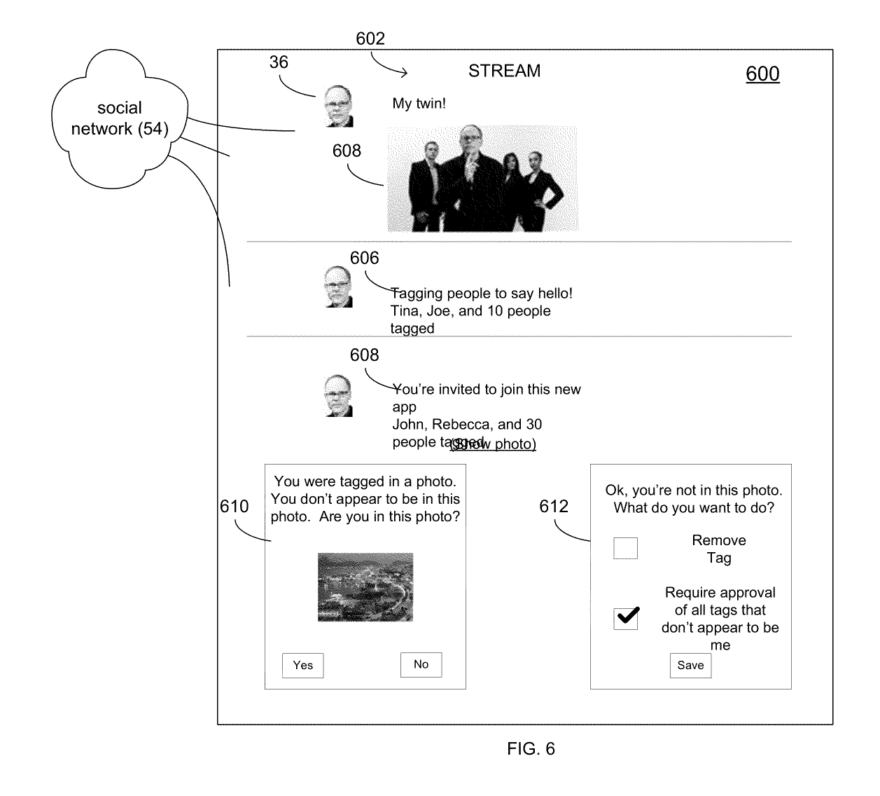

Referring now to FIG. 6, an embodiment of an interface 600 generated by image comparison process 10 is provided. Interface 600 may be configured to provide a user with an option 610 of verifying his/her presence in a particular photograph. Additionally and/or alternatively, each user may select an option 612 of either removing a particular tag and/or requiring approval of a tag that doesn't appear to include an image of the user.

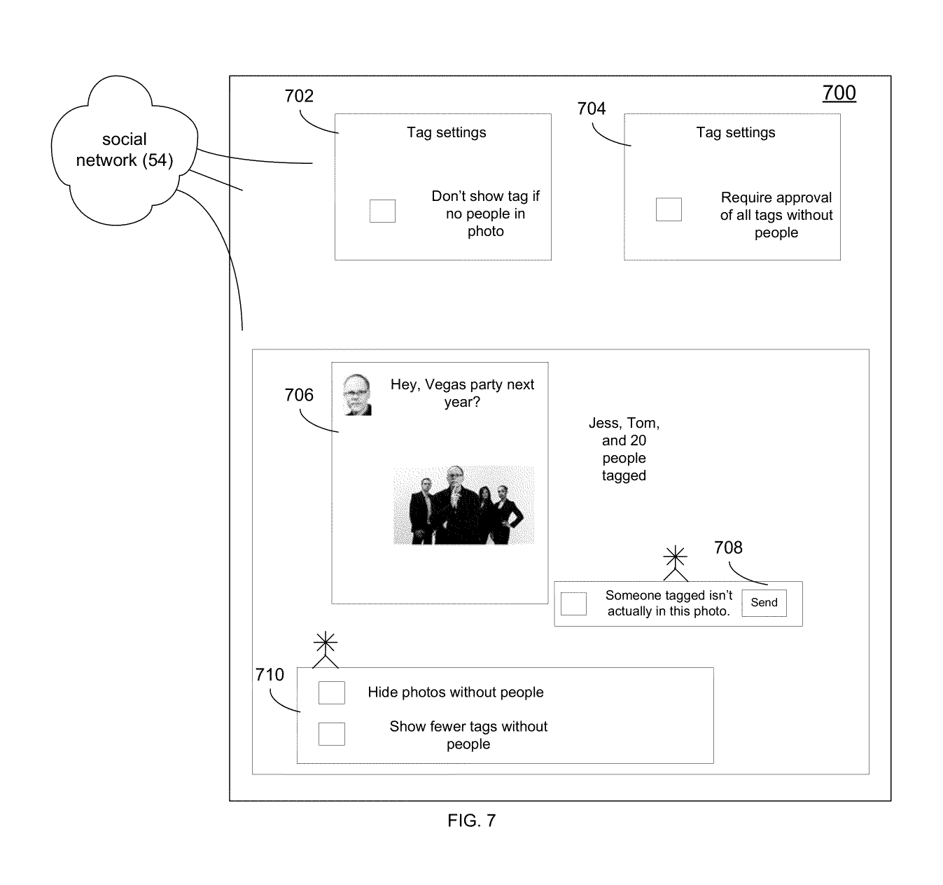

Referring now to FIG. 7, an embodiment of an interface 700 generated by image comparison process 10 is provided. Interface 700 may be configured to provide one or more untagged photographs to a user of the social network. In this particular example, the photograph provided includes individuals who have not yet been tagged. Accordingly, image comparison process 10, upon selection of option 708, may be configured to generate an option for the user to then specify who the individual in the photograph may be.

Additionally and/or alternatively, image comparison process 10 may assign a confidence level to one or more of the tagged images. For example, the confidence level associated with a tagged person may be higher depending upon the person who uploaded the photograph (e.g. the friend, a member of the social network, a person having a high social affinity with the person who uploaded the photograph, etc). In some embodiments, image comparison process 10 may provide user control of tagged photos that appear to not have people. Image comparison process 10 may also provide a user with control to not see photos in stream that do not include people. Image comparison process 10 may also provide a user with the option to see fewer/more photos in a stream that does not have people. Additionally and/or alternatively, image comparison process 10 may provide a user with the option of determining the confidence level of whether or not a person is determined to appear in the photo or not. Image comparison process 10 may also allow a user to report a photo as not including people.

In some embodiments, image comparison process 10 may be configured to identify if no human face is determined to appear. If so, image comparison process 10 may be configured to prevent the display of the first image on the social media stream of the social network. In some embodiments, users may be allowed to control whether posts appear in the stream that have tags on photos that don't appear to have people and/or don't appear to have the friends in the photos who are tagged even if there are other people tagged.

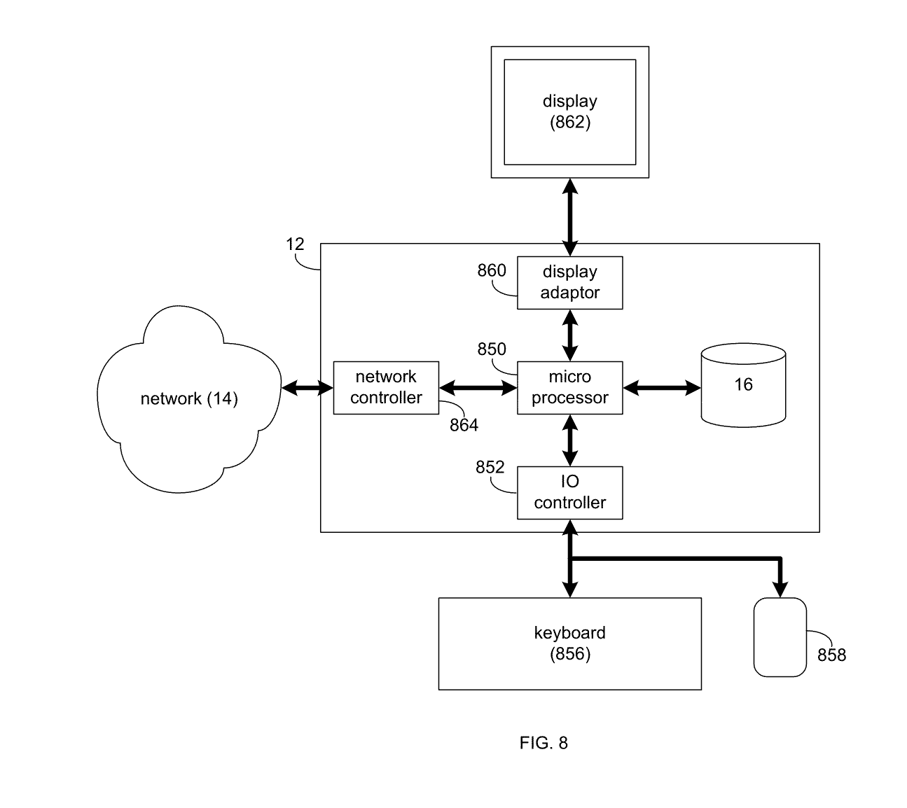

Referring also to FIG. 8, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, image comparison process 10 may be substituted for computing device 12 within FIG. 8, examples of which may include but are not limited to client electronic devices 28, 30, 32, 34.

Computing system 12 may include microprocessor 850 configured to e.g., process data and execute instructions/code for image comparison process 10. Microprocessor 850 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 852 may be configured to couple microprocessor 850 with various devices, such as keyboard 856, mouse 858, USB ports (not shown), and printer ports (not shown). Display adaptor 860 may be configured to couple display 862 (e.g., a CRT or LCD monitor) with microprocessor 850, while network adapter 864 (e.g., an Ethernet adapter) may be configured to couple microprocessor 850 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, on a computing device, a tag associated with a first user concerning a first image within a social media stream of a social network;
scanning the first image to identify whether a human face is present in the first image;
if the human face is identified, comparing the human face to that of the first user, wherein data relating to features of the first user are stored in a database;
if the human face is determined to be associated with that of the first user, allowing the first image to be displayed in a social networking application associated with a second user, wherein the first user and second user are connected within the social network; and
if the human face is not determined to be that of the first user, preventing the display of the first image on the social media stream of the social network.

2. A computer-implemented method comprising:
receiving, on a computing device, a tag associated with a first user concerning a first image within a social network;
scanning the first image to identify whether a human face is present in the first image;
if the human face is identified, comparing the human face to that of the first user; and
if the human face is determined to be that of the first user, allowing the first image to be displayed in a social networking application associated with a second user, wherein the first user and second user are connected within the social network.

3. The computer-implemented method of claim 2 further comprising:
if the human face is not that of the first user, preventing the display of the first image on the social network, wherein preventing the display is connected with a user-selectable option associated with a graphical user interface.

4. The computer-implemented method of claim 2 further comprising:
if the human face is not that of the first user, de-emphasizing the display of the first image on the social network.

5. The computer-implemented method of claim 2 wherein de-emphasizing includes at least one of reducing the size of the first image and adjusting a display position of the first image on the social network.

6. The computer-implemented method of claim 2 wherein allowing occurs as a result of a user-selectable option associated with a graphical user interface.

7. The computer-implemented method of claim 2 wherein comparing includes comparing the human face to a database of contacts associated with the social network.

8. The computer-implemented method of claim 2 further comprising:
providing one or more of the first user and the second user with a notice indicating an incorrect tag is associated with the first image.

9. The computer-implemented method of claim 8, further comprising:
providing one or more of the first user and the second user with an option to remove the incorrect tag from the first image.

10. The computer-implemented method of claim 2 further comprising:
requesting permission from one or more of the first user and the second user prior to allowing the first image to be displayed.

11. A computing system including a processor and memory configured to perform operations comprising:
receiving, on a computing device, a tag associated with a first user concerning a first image within a social network;
scanning the first image to identify whether a human face is present in the first image;
if the human face is identified, comparing the human face to that of the first user; and
if the human face is determined to be that of the first user, allowing the first image to be displayed in a social networking application associated with a second user, wherein the first user and second user are connected within the social network.

12. The computing system of claim 11 further comprising:
if the human face is not that of the first user, preventing the display of the first image on the social network.

13. The computing system of claim 11 further comprising:
if the human face is not that of the first user, de-emphasizing the display of the first image on the social network.

14. The computing system of claim 11 wherein de-emphasizing includes reducing the size of the first image.

15. The computing system of claim 11 wherein de-emphasizing includes adjusting a display position of the first image on the social network.

16. The computing system of claim 11 wherein comparing includes comparing the human face to a database of contacts associated with the social network.

17. The computing system of claim 11 further comprising:
providing one or more of the first user and the second user with a notice indicating an incorrect tag is associated with the first image.

18. The computing system of claim 17, further comprising:
providing one or more of the first user and the second user with an option to remove the incorrect tag from the first image.

19. The computing system of claim 11 further comprising:
requesting permission from one or more of the first user and the second user prior to allowing the first image to be displayed.

20. The computing system of claim 15 wherein adjusting a display position includes adjusting a position of the first image in a social networking stream.
